(19) United States
(12) Patent Application Publication
(10) Pub. No.: US 2013/0015962 A1
(43) Pub. Date: Jan. 17, 2013

(54) SYSTEMS AND METHODS FOR USING GPS TRACKING DATA

(71) Applicant: Rodger Steven Dailey, Sandy, UT (US)

(72) Inventor: Rodger Steven Dailey, Sandy, UT (US)

(21) Appl. No.: 13/548,084

(22) Filed: Jul. 12, 2012

Related U.S. Application Data
(60) Provisional application No. 61/506,836, filed on Jul. 12, 2011.

(51) Int. Cl. G08B 13/14; B60R 25/04

(52) U.S. Cl. 340/426.11; 340/568.1

(57) ABSTRACT

Systems and methods for utilizing location information, including global positioning system (GPS) tracking data facilitate the tracking and protection of assets and the management of location conflicts. Rules are established governing a response of a management system to the receipt of tracking information such that an appropriate action may be taken. When assets move outside of assigned areas or during predetermined times, an appropriate response may be taken to prevent or mitigate theft. Location conflicts may be avoided by detecting location conditions that may lead to various location conflicts. Management of assets is facilitated by the use of the location information.

### CROSS-REFERENCE TO RELATED APPLICATIONS

This application claims the benefit of U.S. Provisional Application No. 61/506,836, filed Jul. 12, 2012.

### BACKGROUND OF THE INVENTION

1. Field of the Invention

The present invention relates to global positioning system (GPS) tracking, and more particularly to systems and methods for using GPS tracking data in conjunction with management of restricted sites, construction sites, geo-fenced areas, and assets.

2. Background and Related Art

In the construction industry, it can be important to know information about where a construction company's assets and inventory are. GPS information can be used to obtain that information, and the advent of ever-less-expensive GPS devices and other similar location devices has facilitated the obtaining of this type of information, which has come to be used in fleet management situations. Thus, when managing a fleet of vehicles, GPS or other tracking information has been used to monitor speed, detect when oil changes or other types of service are needed, and the like. While the use of GPS or other tracking information has increased, the needs of the construction industry as well as other industries are not fully being met by existing technologies.

### BRIEF SUMMARY OF THE INVENTION

Systems and methods for utilizing location information, including global positioning system (GPS) tracking data facilitate the tracking and protection of assets and the management of location conflicts. Rules are established governing a response of a management system to the receipt of tracking information such that an appropriate action may be taken. When assets move outside of assigned areas or during predetermined times, an appropriate response may be taken to prevent or mitigate theft, loss, and/or misuse. Location conflicts may be avoided by detecting and responding location conditions that might otherwise lead to various location conflicts. Management of assets is facilitated by the use of the location information and location history.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an illustrative computer system for use with certain embodiments of the invention;

FIG. 2 shows an illustrative networked computer configuration for use with certain embodiments of the invention;

FIG. 3 shows a tracking system in accordance with certain embodiments of the invention;

FIG. 4 shows an example of a tracking system in accordance with certain embodiments of the invention; and

FIGS. 5-7 show representative views of a browser window for purposes of providing discussion of one way in which remote access to location information may be provided.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Systems and methods for utilizing location information, including global positioning system (GPS) tracking data facilitate the tracking and protection of assets and the management of location conflicts. Rules are established governing a response of a management system to the receipt of tracking information such that an appropriate action may be taken. When assets move outside of assigned areas or during predetermined times, an appropriate response may be taken to prevent or mitigate theft, loss, and/or misuse. Location conflicts may be avoided by detecting location conditions that might otherwise lead to various location conflicts. Management of assets is facilitated by the use of the location information and location history.

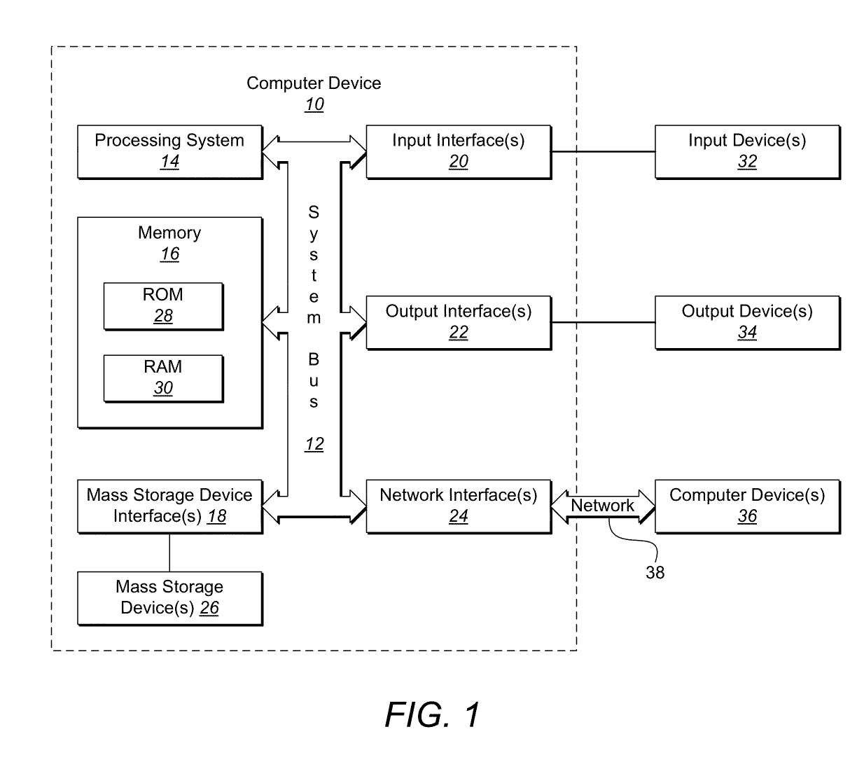

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration and in a cloud computing configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices. Furthermore, in some instances, devices may participate in an Internet-based or cloud-based environment, which may or may not rely on specific identifiable computer devices.

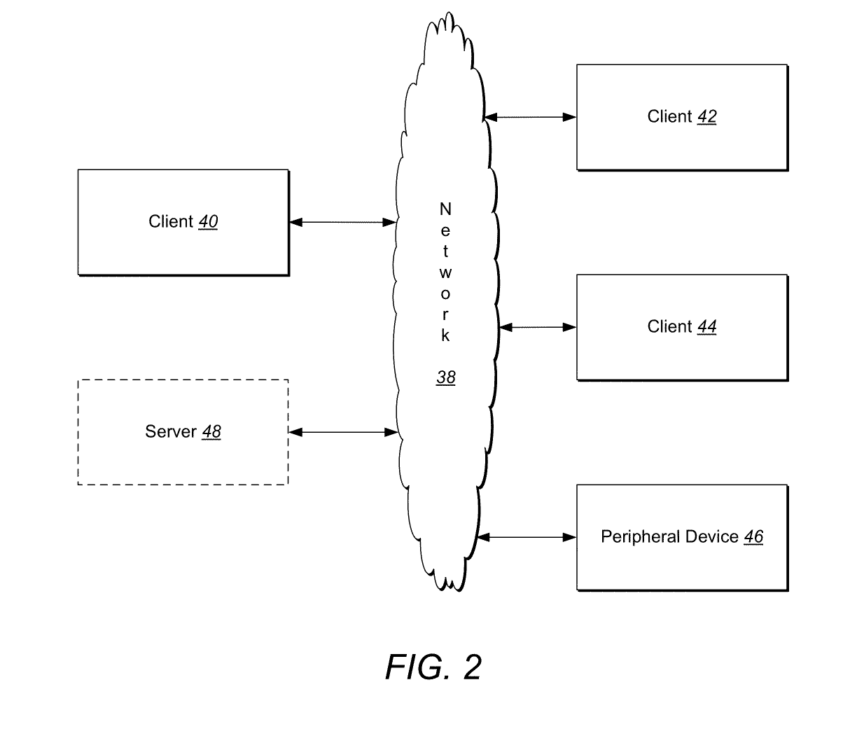

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments and cloud-based networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

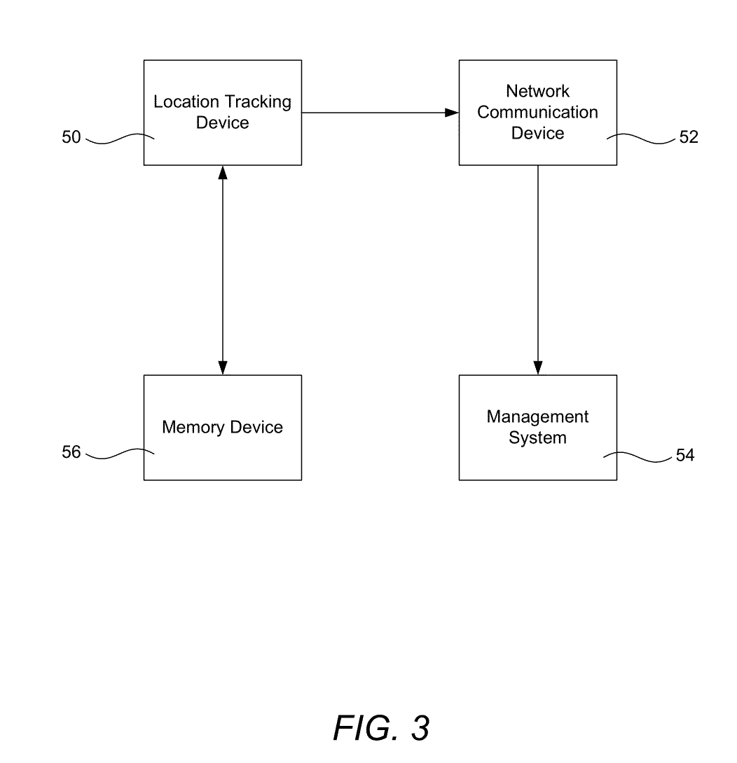

As embodiments of the invention incorporate systems, including networked computer systems, such as those discussed with respect to FIGS. 1 and 2 to utilize tracking information, FIG. 3 illustrates a representative system configuration for providing tracking information to such systems. In the system configuration illustrated in FIG. 3, a location tracking device 50 is communicatively connected to a network communication device 52. The communicative connection between the location tracking device 50 and the network communication device 52 may be substantially constant, it may be intermittent, or it may have any continuity between constancy and intermittency. The communicative connection may be any type of connection, including wired or wireless connection types, and the location tracking device 50 and the network communication device 52 may be separate devices contained in separate housings, or they may be combined into a single effective device contained in a single housing.

When a wireless connection type is used, any type of wireless connection that works appropriately for the given situation may be used. For example, in some situations, it may be anticipated that tracking information will only be needed within a building. If the entire building is covered by a standard Wi-Fi (e.g. 802.11x) network, a WiMAX network, or the like, the network communication device 52 may be configured to connect to or interact with the available network and other types of communication capabilities may be omitted from the device. As another example, if it is anticipated that tracking information will be needed over a broad area where a standard Wi-Fi (e.g. 802.11x) network or the like may not be available but that communication services such as those provided by cellular phone networks will be available, the network communication device 52 may be configured to connect to or interact with an available cellular network or networks. Any type of appropriate wireless communication may be used according to the dictates of a particular circumstance, such that the network communication device 52 may embrace infrared communications technologies, radio frequency identification (RFID) technologies, Bluetooth technologies, satellite phone technologies, microwave communication technologies, or any other now-current or future-used wireless communication technology. The foregoing examples are merely illustrative and are not limiting of the specific type of communication technology.

The purpose of the network communication device 52 is to convey location information received from the location tracking device 50 to a management system 54 over a network such as network 38, including, if applicable, over the Internet. The management system 54 uses the location information in any of the manners discussed herein. In some instances, communication of location information from the location tracking device 50 to the management system 54 using the network communication device 52 may be substantially continuous, and in other instances, communication of location information from the location tracking device 50 to the management system 54 using the network communication device 52 is sporadic, periodic, or intermittent. For example, in instances where a communicative connection between the location tracking device 50 and the network communication device 52 or between the network communication device 52 and the management system 54 is not continuously available, such as due to unavailability of access to the network, lack of communication between the location tracking device 50 and the network communication device 52, and the like, location information from the location tracking device 50 may be provided only when an appropriate communicative connection is available.

Because location information other than then-current location information may be useful to the management system 54 as will become apparent from the discussion herein, and because the communicative connections between the location tracking device 50 and the management system 54 may not always be available, the location tracking device 50 of some embodiments may optionally be connected to a memory device 56 permitting storage of location information over time for later retrieval and transmission to the network communication device 52 and/or for retrieval by other means including by direct external retrieval from the memory device 56. Where the memory device 56 is present, the location tracking device 50 determines whether storage of location information is desirable and stores appropriate location information accordingly.

While unavailability of one or more of the communicative connections between the location tracking device 50 and the management system 54 is one reason why continuous communication of tracking information between the location tracking device 50 and the management system 54 may not occur, it is merely one example of such a reason. As another example, if the location tracking device 50 is stationary such that the location information is unchanged, it may not be necessary to continuously communicate the unchanged location information. Therefore, some embodiments embrace a reduced frequency of transmission of location information by the location tracking device 50. As one example, the transmission of location information may be interrupted until the location information changes, or the transmission of location information may be made periodic or intermittent until the location information changes so as to allow the management system 54 to confirm from time to time that the location information has not changed. The reduction of frequency of transmission of the location information may conserve power as well as communications or network resources.

The location tracking device 50 may obtain location information in any of a variety of fashions. In one example, the location tracking device 50 obtains location information using the GPS system, whereby the location tracking device 50 incorporates a GPS device. The use of GPS information allows for fairly-precise localization in a broad variety of circumstances and with commonly-available technology. In some instances, other technology may be used as an alternative or supplement to GPS information and technology. For example, in some circumstances, such as inside buildings or as a result of certain geographical features, GPS signals may not be available. Therefore, certain embodiments of the invention embrace other forms of localization technology, including triangulation technology such as from cell phone towers or other signal sources and near-field radio communications (e.g. radio frequency identification or RFID) that may be used to provide location data. These are merely examples of potential location information technologies that may be used with embodiments of the invention, and it should be understood that any localization technology or information currently in existence or later created may be used with embodiments of the invention. For present purposes of illustration only, the remainder of this discussion will focus on the use of GPS location information.

The network communication device 52 may be any type of communications device that permits or establishes communication between the location tracking device 50 and the management system 54. Thus, for example, the network communication device may include or incorporate a proprietary electromagnetic (e.g. radio) transmission device transmitting and/or receiving signals to permit communication. As another example, the network communication device 52 may include a device configured to operate with today's cellular networks. As another example, the network communication device 52 may include a wireless communication device configured to interact with a standard Wi-Fi (e.g. 802.11x) network, a WiMAX network, or the like. In such configurations, the location information may be communicated to the management system 54 at times when the location tracking device 50 and/or the network communication device 52 are located in range of a compatible network or network device. Where applicable, the location information communicated at such times may include current location information as well as past information location stored in the memory device 56.

The management system 54 may be maintained and controlled by any desirable entity.

For example, a construction company could obtain and manage its own management system 54. Alternatively, to avoid the cost of obtaining, maintaining, and managing its own management system, a construction company could contract with a different entity to provide location tracking devices 50 and any other necessary equipment, and to operate the management system 54. The separate entity could then provide information and/or any applicable alerts to the construction company, such as part of a subscription service.

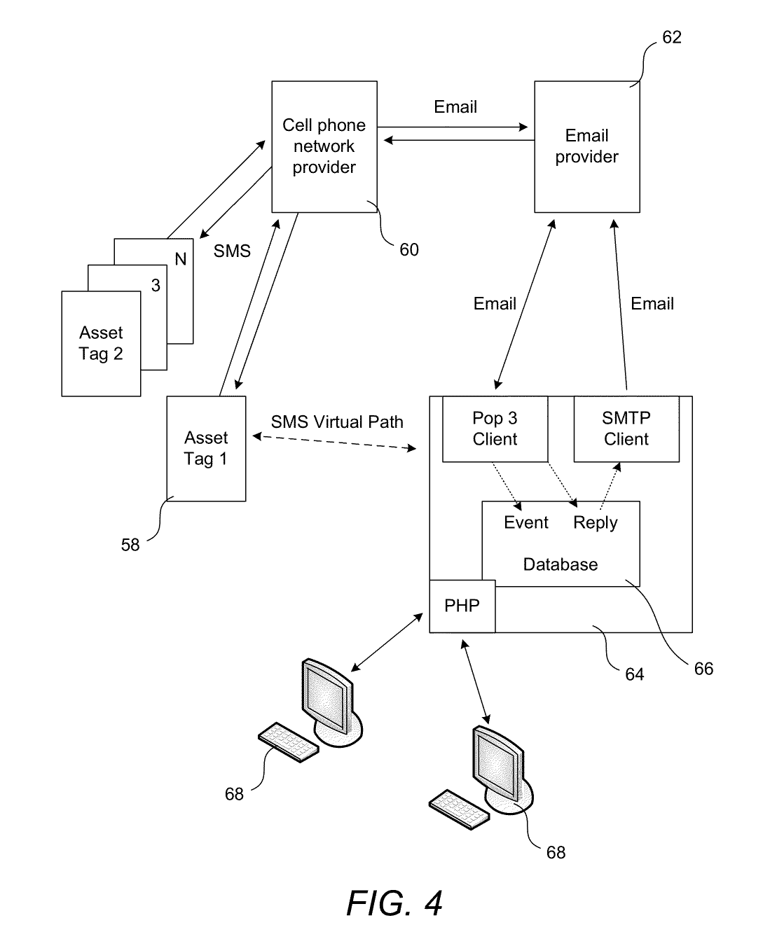

FIG. 4 illustrates one example of a system to provide a subscription service, although a similar configuration could be used wholly within a single organization, and the system illustrated in FIG. 4 is only provided by way of illustration of the concepts discussed herein. In FIG. 4, the location tracking device 50 and the network communication device 52 are combined in an asset tag 58. The asset tags 58 may be purchased by the entity subscribing to the service, and may be attached to or placed within one or more assets the subscriber wishes to track. The subscriber may purchase or rent as many asset tags 58 as desired or needed, and either the subscription service registers the asset tags to the subscriber, or the subscriber accesses the service and registers that the subscriber possesses the asset tags. The subscriber may also register or record which asset tags are associated with which assets.

In the illustrated example, the asset tags 58 are capable of communicating with a cell phone network provider 60 via short messaging service (SMS) (e.g. text) messages. Thus, in this example, the asset tags 58 include whatever equipment is necessary for obtaining location information (e.g. GPS), equipment to communicate with the cell phone network provider 60, and power supply equipment (e.g. battery, solar cell, or connection for an external power source). To minimize cost of manufacture and/or to reduce power needs, the asset tags 58 may not include any unnecessary equipment.

As illustrated in FIG. 4, the cell phone network provider 60 receives SMS messages from the asset tags 58, and according to rules previously established, generates and transmits emails to an email provider 62, which may be any email provider. The email provider 62 may be associated with the subscription service, or it may further transmit emails to and from the subscription service, as is illustrated in FIG. 4, in which the email provider 62 transmits to and receives emails from a subscription computer system 64. The subscription computer system 64 maintains a database 66 that keeps track of and manages location information and rules information to provide the functionality discussed herein.

The subscriber may access the subscription computer system 64 to obtain location information and establish rules information using a remote client 68. The subscription computer system 64 may provide information to the remote client 68 in any known or later-invented way, including by way of a custom computer program installed on the subscriber's remote client 68. Alternatively, the subscription computer system 64 may be made accessible by way of a network (e.g. the Internet) and a network access program, such as a browser. In some instances, the subscriber may access the subscription computer system 64 through the user's browser without installing any specialized programs on the remote client 68.

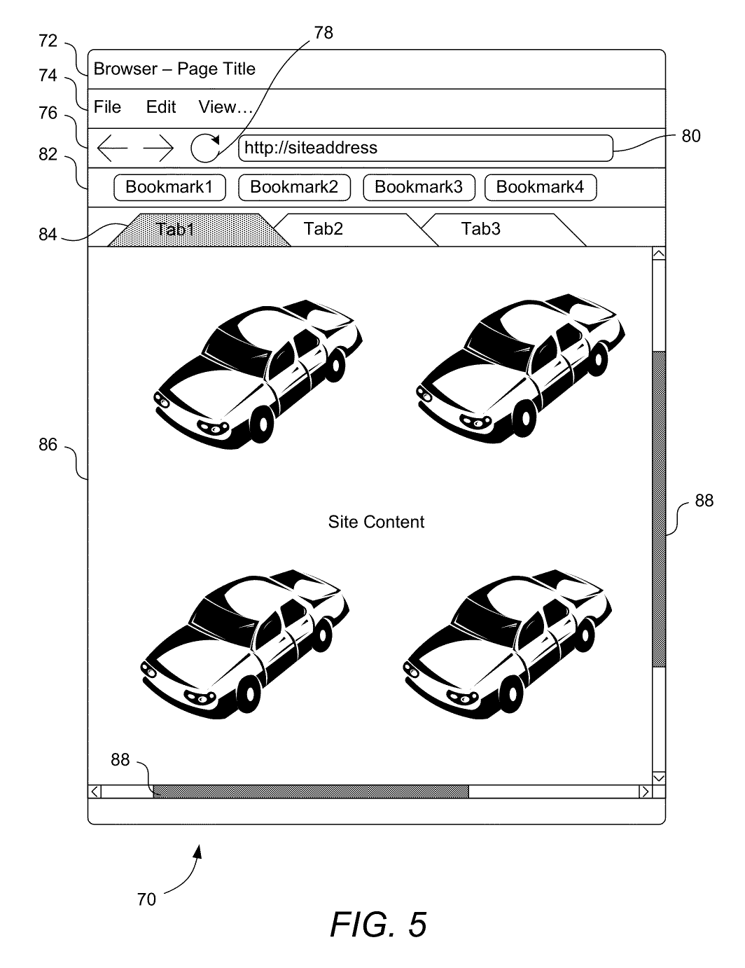

Thus, to minimize the need to download and/or install programs on users' computers, embodiments of the invention utilize existing web browser technology. Many browser programs currently exist or are under development, and it would be impossible to name all such browser programs, but examples of such programs include Microsoft's Internet Explorer, Mozilla Firefox, Google Chrome, Apple Safari, Opera Software's Opera browser, as well as myriad browsers specifically configured for specific devices, such as Internet-connected smart phones and the like. While the exact display of each browser can vary from browser to browser and while most are moderately to highly configurable so as to vary the exact display, FIG. 5 shows a representative browser window 70 similar to what might be displayed on a user's computer device. It will be appreciated that many of the features described below with respect to the illustrated browser window 70 are optional or are optionally displayed or hidden as desired by the user, but each feature is typical or illustrative of features common to many browser programs.

The browser window 70 of FIG. 5 includes a title bar 72. The title bar 72 often is used to display a page name of whatever page is actively being viewed. Most commonly, the page name that is displayed is selected by the administrator of the website being viewed, and the page name often includes one or more phrases associated with the administrator of the website and/or the page being viewed. The browser window 70 also includes a menu bar 74 that includes items that may be selected to provide access to various menu functions, as is well known in the art. Of course, the menu functions provided in the menu bar 74 may vary according to the specific browser program, among other considerations, and access to menu functions may be provide other than by a menu bar similar to menu bar 74.

The browser window 70 of FIG. 5 also includes an address bar 76, which in the browser window 70 shown in FIG. 5 includes several browser controls 78 and an address entry area 80. The browser controls 78 and the address entry area 80 facilitate browsing using the window, permitting the user, for example, to go back one or more pages, to go forward one or more pages, to refresh a page, and/or to type in a destination site's address to directly access a page. Such browser features are well known in the art and need not be further discussed.

The browser window 70 also includes a bookmark bar 82 that a user can populate with bookmarks to commonly-accessed web pages, such that the user can quickly re-access the page(s) by clicking on the relevant bookmark button. In most common browser programs, it is possible for the user to have several different websites open simultaneously, and for the browser to provide rapid access, switching between, and management of the various open sites by way of various tabs 84, as shown in FIG. 5. Each tab 84 provides access to one open website. The tabs 84 facilitate navigation between different open websites. The contents of each open and actively-viewed website may be displayed in a content area 86. Thus, the content displayed in the content area 86 may vary depending on which tab 84 is selected, and which website is being viewed.

Whereas the tabs facilitate navigating between different websites, the browser window 70 optionally includes features to facilitate navigating within a website, as is known in the art. Specifically, the browser window may optionally include one or more scroll bars 88. When a portion of the website being viewed lies outside of the viewable portion of the content area 86, the user may use the scroll bars 88 to access non-visible portions, as is known in the art.

Many currently-available browser programs permit the installation of additional features, such as through what are commonly known as “browser extensions.” Browser extensions are becoming more and more common in today's browser programs, and have become one of if not the standard for extending the functionality of the browser programs. For browsers that do not currently support browser extensions, other mechanisms and installed programs are often available to provide similar functionality.

Embodiments of the invention utilize a browser extension or similar format to provide functions in accordance with embodiments of the invention. The use and installation of a browser extension is typically significantly less involved and less computer-intensive than the use and installation of a stand-alone program. In many instances, the installation of the browser extension occurs essentially without the computer's operating system being made aware of any additional installation. Instead, the browser program itself handles the browser extension and any demands made by the browser extension.

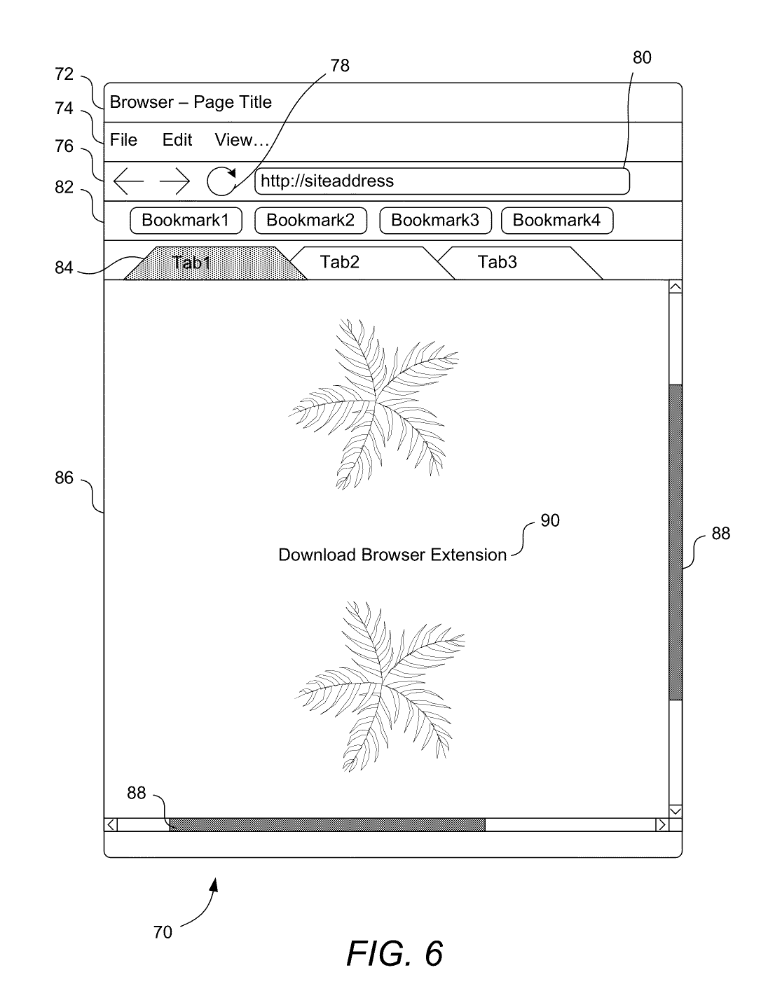

A browser extension in accordance with embodiments of the invention, for example, may be rapidly and easily installed, such as by visiting a download website. An example of such a website is shown in FIG. 6. A user desiring to obtain functionality associated with embodiments of the invention may visit a website such as that illustrated in FIG. 6, and may select an installation link 90. Upon selection of the installation link 90, the user may be prompted to confirm in one or more steps that he or she wishes to download and install the browser extension. If the user confirms that the browser extension is to be downloaded and installed, the download and installation is completed.

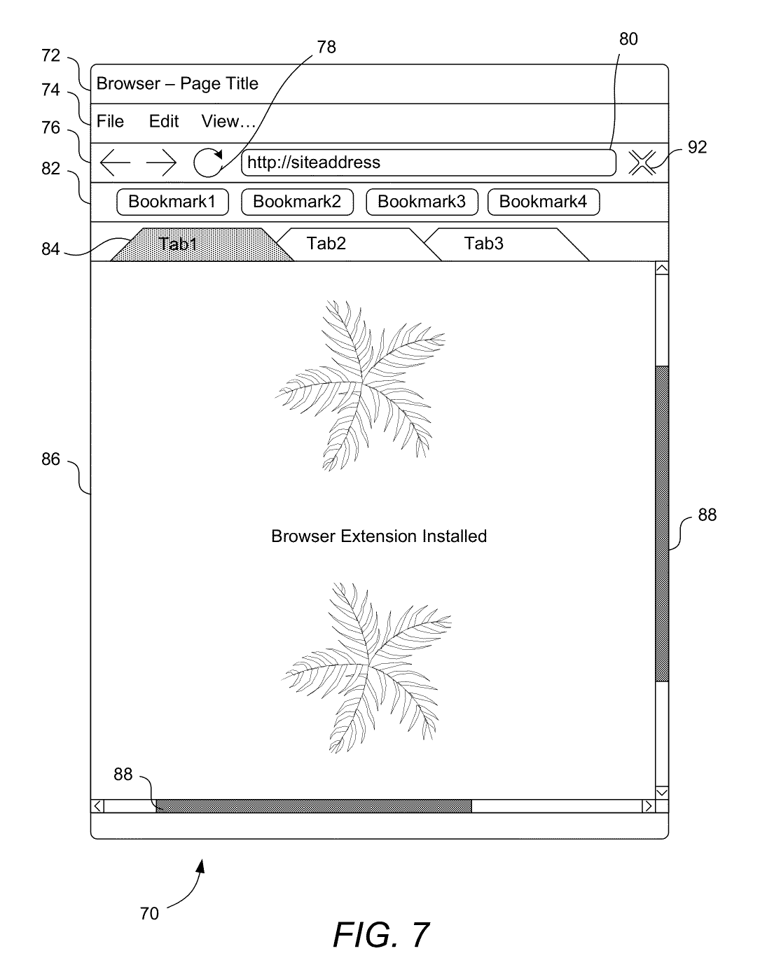

Access to the browser extension may be provided according to any method known in the art, but one example is shown in FIG. 7, in which it can be seen that a browser extension icon 92 has been added to the address bar 76. Of course, where an icon such as the browser extension icon 92 is provided, it may be provided at any desirable location or on any desirable toolbar, including a new toolbar, within the browser window 70. Additionally, features provided by the browser extension may alternatively be accessed by one or more menu functions accessed through a browser menu or any other similar mechanism, as well as by any means or mechanism for accessing such functions now known in the art or later created.

Once the browser extension has been installed (which is a relatively easy process as described above), the browser program and the browser extension may be used to provide functions in accordance with embodiments of the invention. While the specific functionality of the browser extension may be varied in essentially infinite ways while maintaining the functionality that will be discussed herein, including customizations for each user to facilitate each user's access, a description of ways in which that functionality may be provided is given below or may be understood from the discussion herein.

While the browser window 70 of FIGS. 5-7 and/or the browser extension have been discussed and shown herein generally without specific location information, it will be appreciated that the browser window 70 will be modified from the views of FIGS. 5-7 to show information relevant to the tracking functions discussed herein. Thus, the browser window 70, either natively or under direction of the browser extension may have the content area 86 modified to display location information and/or menus, asset tag registration information and/or menus, rule information and/or menus, and the like. It will be appreciated that there are essentially infinite ways in which the information may be arranged and/or displayed within the content area 86.

Installation of a browser extension may expand the options available to the subscriber for tracking and managing assets using the asset tags 58. For example, the browser or the browser extension may be configured to provide alerts and notification as discussed herein. Similarly, the use of a browser extension may allow the subscriber to access functions of the system while minimizing network traffic and the like. Regardless of whether or not a browser extension, a browser without browser extension, or a stand-alone program are used, the communication between the remote client 68 and the subscription computer system 64 allows the subscriber to obtain information about its assets and to manage those assets better.

As is illustrated in FIG. 4, the system set out in the Figure shows one way in which a virtual SMS path may be established between the asset tags 58 and the subscription computer system 64 such that the asset tags 58 may be limited in communication technology to SMS but may communicate with the subscription computer system 64 without requiring that the subscription service provide its own SMS service. Instead, the subscription service provider is able to leverage existing SMS services to provide additional functionality not currently available.

As is illustrated in FIG. 4, the communication between the asset tags 58 and the subscription computer system 64 may be bi-directional communication, such that the asset tags 58 may receive instructions from the subscription computer system 64. For example, the asset tags 58 may receive instructions regarding when or how often to communicate location information via SMS. Alternatively, the asset tags 58 may receive an instruction to transmit their current location information. In instances where additional functionality is provided to the asset tags 58, the additional functionality may be controlled by incoming SMS messages. For example, if an asset tag 58 is configured to interrupt or disable a vehicle to which it is attached, an incoming SMS signal could instruct the asset tag 58 to interrupt or disable the vehicle. These are merely examples of possible purposes of bi-directional communication.

As mentioned above, FIG. 4 illustrates a specific system for purposes of illustrating concepts associated with certain embodiments of the invention. For convenience, the remainder of this discussion will refer generally to the management system 54 of FIG. 3, which is a more general embodiment. The management system 54 of FIG. 3 might be deemed to include any or all elements of the specific system depicted in FIG. 4 other than the asset tags 58.

The location information received by the management system 54 may be used in a variety of fashions. By way of illustrative example, ways in which the location information may be used in the construction industry will be discussed. In the construction industry, it can be important to track and manage assets, inventory, and equipment, and embodiments of the invention facilitate such tracking and management. Within the construction industry, there are a wide variety of sizes of construction companies and associated projects, and embodiments of the invention may be utilized with any size company or project. By way of example only, a construction company may contract to build or rebuild a road. Such a project may involve work extending over many miles of the road, and it can be important to have accurate location information within the project and also for assets, equipment, and materials needed for the project but offsite. As another example, a construction company may be involved in building a large building. While such a project may potentially have a more-compact site than with the road-building project, it may still be important to have accurate location information within the site and off site.

Therefore, for example, the system may be used to track and manage a vehicle fleet or any other assets of a construction company. Tracking of a vehicle fleet and other assets of the construction company may allow the construction company to know what vehicle assets and other assets are at what locations. The location information may also be used to determine maintenance needs (e.g. based on miles driven), to monitor employee behavior such as to ensure that employees obey speed limits and are at assigned locations, or for any other relevant purpose. If, for example, an onsite manager determines that a particular type of vehicle or other asset is needed at a particular location on the project, the management system 54 may be queried to locate the closest vehicle or other asset of that type, or the vehicle or other asset of that type most readily able to reach the desired work location. The management system can then be used to manage fleet assets and other assets by instructing that the desired vehicle or other asset be sent to the new location. If the assigned vehicle or other asset is not available, the management system 54 may be queried to find the next most appropriate vehicle or other asset, and so forth.

To facilitate the management of the vehicle fleet and other assets in this manner, each vehicle or other asset includes one of the location tracking devices 50. Each of the location tracking devices 50 may include a unique identifier and may be programmed to inform the management system 54 of its location from time to time, continuously, sporadically, intermittently, on demand in response to a query of the location tracking devices 50, etc., as appropriate. The management system 54 then uses any appropriate location information and identifying information to track each of the vehicles and other assets.

Thus, the location tracking devices 50 may also be used to provide tracking information to the management system 54 for pieces of equipment, inventory, and other assets. For example, in the construction industry, certain items of equipment may not be normally or always mounted on or contained in a vehicle, but it may be important to know where the equipment is when it is needed. The tracking information provided by the location tracking device 50 allows the location of the equipment to be monitored and recorded for when the equipment is needed. Similarly, certain assets or inventory to be used in a construction project may be delivered to the construction project, but may not be immediately needed. Therefore, the assets or inventory may be stored for a time until needed. The tracking information may allow such inventory or assets to be quickly located when needed.

Some embodiments of the invention are used to provide security and protection to vehicles, assets, inventory, and/or equipment. Take, as an example, the storage of inventory to be used at a later date in the construction project. During the period of time when the inventory is to be stored, it can be expected that the stored inventory will not be moved, will only be moved short distances (as with the shifting of inventory items to retrieve other inventory items), or should not leave the construction site. In such situations, the management system 54 may be programmed with an alert or rule indicating that when certain changes in the tracking information for the inventory items are received, the changes are deemed to be abnormal, potentially indicating an attempted theft of the inventory items. Therefore, an alert or notice can be provided by any applicable means, so as to prevent theft and/or permit retrieval of thieved items and/or apprehension of thieves or would-be thieves.

Geo-fencing is one example of a method or mechanism for establishing a rule for providing alerts in accordance with embodiments of the invention. A geo-fence may be a virtual boundary that is established for one or more items or tracking devices 50. The virtual boundary may correspond with an actual boundary, or it may be defined so as to vary from actual boundaries in one or more manners. The virtual boundary may be automatically or semi-automatically defined for each tracking device 50 based on one or more rules, or it may be manually established by a user. In some instances, layers of virtual boundaries may be established, with varying rules or alerts provided in response to varying occurrences in respect to one or more virtual boundaries.

Thus, in such examples, if movement of the inventory is detected that exceeds, for example, one hundred feet, or that is outside of an assigned work or storage area, alerts or other actions may be taken to respond accordingly. Other actions may be taken where applicable and available. For example, if the location tracking device 50 is included in a vehicle, the location tracking device 50 or some other device may be equipped with a capability to disable the vehicle and/or prevent starting of the vehicle. Thus, when the vehicle is detected moving outside of its assigned area for any reason, it may potentially be disabled. Similarly, an unused vehicle or piece of equipment that is not being used may be disabled by the management system 54 until it is needed, and any movements of the vehicle or piece of equipment that are detected during the state of being disabled may trigger alerts as discussed above.

In some embodiments, the tracking information may be used in conjunction with time information to provide applicable alerts and other response. For example, the management system 54 may be programmed to provide alerts or take other action based on movement occurring after normal work hours. This may be especially applicable, for example, in situations where it is difficult or impossible to return vehicles or equipment to secured storage areas at the end of each work period. Because the cost of monitoring the location of the equipment, vehicles, or any other assets is comparatively low, significant savings may be achieved over protection schemes requiring time and energy to move the assets to secured areas at the end of each work period.

Similarly, if a vehicle is being driven in a fashion that is unsafe, such as by exceeding a known speed limit, some embodiments may be used to safely disable the vehicle and thereby potentially prevent accidents. As may be appreciated, such systems may reduce or prevent potential liability on the part of the construction company or essentially any other entity.

The tracking information may also be used for auditing purposes. For example, maintenance of a particular vehicle may be due, and a maintenance shop assigned to perform the maintenance. The maintenance shop may report that maintenance has been performed, but the location records maintained by the management system 54 may show that the vehicle never was taken to the maintenance shop. Such records can then be used to take corrective action.

Some embodiments of the invention provide for conflict and/or accident avoidance. In some construction sites, for example, certain areas of the construction sites are maintained off-limits to all vehicles or to certain vehicles. For example, large vehicles may be excluded from entering areas lacking sufficient maneuverability for the vehicles. Similarly, areas with hazards, storage areas, active work areas, or essentially any area may be designated as an exclusion area for certain types of vehicles or equipment, and virtual fences may be established on the management system 54 indicative of the applicable restrictions. When a restriction is violated, any applicable action could be taken. For example, an offending vehicle may be disabled until communication can be established with the vehicle's driver to ensure that the driver is aware of the restriction and can exit the restricted area. Alternatively, an on-site employee may be notified of the violation to allow the on-site employee to respond in person. These are simply examples of a large variety of actions that can be taken.

As another example, in many situations, a movement corridor (e.g. a roadway) of a worksite may only be able to permit transport of a single vehicle at a time. In some such circumstances, the entirety of the corridor may not be visible from either end, such that a vehicle desiring to enter the corridor from one end cannot know whether a vehicle is traversing the corridor in the other direction towards the first vehicle. If the first vehicle were to enter the corridor, it could create a conflict such that one vehicle might have to backtrack a portion of the corridor, in reverse, which could be difficult. The system may be used to avert potential conflicts by determining whether any potential conflicts exist before each vehicle enters the corridor. While use of such a system has been discussed with respect to a worksite, the principles of conflict avoidance illustrated thereby may be applicable to many situations, such as airport traffic control, movement within a warehouse, or any other desired situation.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A location tracking system comprising:
a location tracking device configured to transmit location information through a network communication device;
the network communication device; and
a management system communicatively connected to the location tracking device through the network communication device and configured to utilize the location information to protect assets of a business.

2. A location tracking system as recited in claim 1, wherein the management system is configured to utilize the location information to monitor the location of an item and provide an alert when the item's location is changed, thereby preventing theft.

3. A location tracking system as recited in claim 2, wherein the alert is provided when the item exits a given area.

4. A location tracking system as recited in claim 2, wherein the alert is provided when the item's location changes more than a predetermined amount.

5. A location tracking system as recited in claim 2, wherein the alert is provided when entry of the item into an unsafe area is detected.

6. A location tracking system as recited in claim 1, wherein the management system is programmed with one or more virtual fences, such that when the location information indicates that the location tracking device has crossed a virtual fence, the management system provides an alert.

7. A location tracking system as recited in claim 1, wherein the management system is programmed to detect and mitigate location conflicts between vehicles.

8. A location tracking system as recited in claim 1, wherein the location tracking device comprises a global positioning system (GPS) device.

9. A location tracking system as recited in claim 1, wherein the system further comprises a device configured to interrupt operation of a vehicle based on a response to location information programmed in the management system.

10. A location tracking system as recited in claim 1, wherein location information is communicated to the management system one of over the Internet and by a short messaging service (SMS) message.

11. A method for location tracking comprising:
providing a location tracking device to an item to be tracked;
establishing communication between the location tracking device and a management system over a network;
establishing location rules on the management system such that upon detection of location information satisfying the location rules, the management system is programmed to respond to the location information according to the location rules;
receiving location information transmitted from the location tracking device to the management system over the network;
comparing the received location information to the location rules; and
when the received location information satisfies the location rules, performing an action dictated by the location rules.

12. A method as recited in claim 11, wherein the location rules are established to prevent theft of monitored items.

13. A method as recited in claim 11, wherein the location rules are established to prevent location conflicts.

14. A method as recited in claim 11, wherein the location rules are based on movement outside of predefined areas.

15. A method as recited in claim 11, wherein the location rules are based on movement occurring during predefined times.

16. A method as recited in claim 11, wherein the location rules are based on movement exceeding a total movement amount.

17. A method as recited in claim 11, wherein the location information comprises global positioning system (GPS) information.
